(19) United States
(12) Patent Application Publication
(10) Pub. No.: US 2012/0304508 A1
(43) Pub. Date: Dec. 6, 2012

(54) A WEAR MEMBER ASSEMBLY

(75) Inventors: Miguel Guimaraes, Mackay (AU); Bruce Lilley, Mackay (AU)

(73) Assignee: COMS Pty Ltd, Mackay Queensland (AU)

(21) Appl. No.: 13/514,901

(22) PCT Filed: Dec. 10, 2010
(86) PCT No.: PCT/AU2010/001676

§ 371 Date: Aug. 14, 2012

(30) Foreign Application Priority Data
Dec. 11, 2009 (AU) 2009906065
Jul. 14, 2010 (AU) 2010903142

(51) Int. Cl. E02F 9/28; B23P 11/00

(52) U.S. Cl. 37/457; 29/525.08; 37/456; 37/455

(57) ABSTRACT

A wear member assembly for a lip of an earth excavating device comprises a first wear member, a second wear member and a retaining pin. The first wear member is mounted to the lip. The first wear member includes a boss extending outwardly from one of its opposite sides. The second wear member is mounted adjacent the first wear member. The second wear member includes a socket in one of its sides. The socket is adapted to receive the boss of the first wear member. The second wear member includes a retaining pin passage in communication with the socket. The retaining pin is removably located in the retaining pin passage. The retaining pin has a first bearing face adapted to oppose and engage a face of the boss received in the socket and a second bearing face which bears against a load bearing face of the retaining pin passage.

### FIELD OF THE INVENTION

This invention is concerned with a wear member assembly for earth excavating devices. The invention is concerned particularly, although not exclusively, with the mounting of a lip shroud to a lip by retaining the lip shroud between excavating tooth assemblies.

### BACKGROUND OF THE INVENTION

Excavator tooth assemblies mounted to the lip of excavator buckets and the like generally comprise a replaceable digging tooth and an adaptor which is secured by welding or the like to the lip of a bucket or the like. The adaptor may in some instance comprise an adaptor body and an adaptor nose welded to the lip. The adaptor body has a socket-like recess at its rear end to receivably locate a spigot portion of the adaptor nose. The digging tooth is mounted to the front end of the adaptor body.

The excavator tooth assemblies are regularly spaced along the lip. In order to protect the lip from wear, lip shrouds may be mounted to the lip, between the excavator tooth assemblies. The lip shrouds are subject to extensive load forces, including twisting forces. A strong mount is required between the lip shrouds and the lip. The lip shrouds generally have spaced apart legs between which the lip is received in a tongue-in-groove fashion to mount the lip shroud to the lip.

Various systems have been proposed to retain the lip shrouds in their position mounted to the lip. One such system is described in U.S. Pat. No. 4,625,437 wherein the lip shroud has holes in the legs. The lip shroud is retained on the lip by welding a formation to the lip and within the holes in the legs. This has the drawback that the lip shrouds can only be removed by removing the formation welded to the lip. Lip shrouds have to be removed for maintenance or when they are worn and need replacement. Removing the welded formation is unnecessarily cumbersome to replace the lip shroud.

Another system as described in U.S. Pat. No. 4,452,529 has the lip shrouds secured to the lip by a pin which extends through the lip shroud and the lip.

The excavator tooth assemblies are subject to extensive load forces along a longitudinal axis of a tooth as well as in vertical and transverse directions. The adaptors of the excavator tooth assemblies are generally welded to the lip. There is thus a risk of losing the digging tooth assembly when the weld fails. The prior art mounting systems do not aid in distributing load on the excavator tooth assemblies to the lip.

While generally satisfactory for their intended purpose, the abovementioned prior art mounting systems all suffer from one or more shortcomings or disadvantages in terms of inadequate resistance to load, a mount of limited strength, difficulty in replacement of worn lip shrouds and failure to distribute load between wear members.

It is an aim of the present invention to overcome or alleviate at least some of the abovementioned prior art disadvantages or otherwise to provide consumers with a convenient choice.

### SUMMARY OF THE INVENTION

According one aspect of the invention there is provided a wear member assembly for a lip of an earth excavating device, the wear member assembly comprising:
a first wear member mounted to the lip, the first wear member having a front end, a rear end, and opposite sides, the first wear member including a boss extending outwardly from at least one of the opposite sides;
a second wear member mounted on the lip adjacent the first wear member, the second wear member having a front end, a rear end, and opposite sides, the second wear member including:
   a socket in at least one of the opposite sides, the socket adapted to receive the boss of the first wear member;
   a retaining pin passage in communication with the socket; and
a retaining pin removably located in the retaining pin passage, the retaining pin having a first bearing face adapted to oppose and engage a face of the boss received in the socket and a second bearing face which bears against a load bearing face of the retaining pin passage.

The first wear member is preferably an adaptor of an excavator tooth assembly and the second wear member is preferably a lip shroud.

The adaptor preferably has a boss extending from both opposite sides. Similarly, the lip shroud has a socket, socket passage and retaining pin passage in both opposite sides.

The lip shroud is preferably mounted between two excavator tooth assemblies.

According to a second aspect of the invention there is provide a lip shroud adapted to be mounted on a lip of an earth excavating device, the lip shroud having a front end, a rear end, and opposite sides, the lip shroud including:
a socket in at least one of the opposite sides;
a retaining pin passage in communication with the socket, the retaining pin passage adapted to receive a retaining pin

According to another aspect of the invention there is provided a retaining pin comprising:
a lock member having a head and a shank, the lock member including a lock formation on the shank distal to the head; and
a body member having opposite ends and a bore extending between the opposite ends, the bore adapted to receive the shank of the lock member, the body member including a tapered portion at one of the opposite ends;
wherein the lock formation is located outwardly of the body member when the shank is received in the bore.

According to still another aspect of the invention, there is provided an adaptor mountable to a lip of an earth excavating device, the adaptor having a front end, a rear end, and opposite sides, the adaptor including a boss projecting from at least one of the opposite sides, the boss comprising a raised base on the at least one of the opposite sides and a nub extending from the base.

According to yet another aspect of the invention, there is provided a method of releasably mounting a second Wear member adjacent a first wear member mounted to a lip of an earth excavating device, the method including:
displacing the second wear member relative to the first wear member such that a boss extending outwardly from a side of the first wear member is displaced into a socket in the side of the second wear member;
locating a retaining pin in a retaining passage of the first wear member such that a first bearing face of the retaining pin opposes and engages a face of the boss received in the socket and a second bearing face of the retaining pin opposes and engages a load bearing face of the retaining pin passage.

Any reference in this specification to an adaptor of an excavator tooth assembly must be interpreted to include a nose of an excavator tooth assembly as is known in the art of excavator buckets.

### BRIEF DESCRIPTION OF THE DRAWINGS

In order that the invention may be more fully understood and put into practical effect, reference will now be made to the accompanying drawings in which:

FIG. 1 shows a perspective view of a wear member assembly including a number of lip shrouds according to one aspect of the invention mounted to a lip of an earth excavating device and retained between excavator tooth assemblies;

FIG. 2 shows a perspective part-exploded view of one of the lip shrouds of FIG. 1 and accompanying retaining pin assemblies for retaining the lip shroud mounted on the lip;

FIG. 3 shows a perspective view of one of the lip shrouds of FIG. 1;

FIG. 4 shows a top view of the lip shroud of FIG. 3;

FIG. 5 shows a side view of the lip shroud of FIG. 3;

FIG. 6 shows a perspective view of an adaptor of the excavator tooth assemblies of FIG. 1;

FIG. 7 shows a side view of the adaptor of FIG. 6;

FIG. 8 shows a top view of the adaptor of FIG. 6;

FIG. 9 shows an exploded perspective views of one of the retaining pin assemblies of FIG. 2;

FIG. 10 shows a top view of a foot-piece of the retaining pin assembly of FIG. 9;

FIG. 11 shows a bottom view of the foot-piece of the retaining pin assembly of FIG. 9;

FIG. 12 shows a sectional view of the foot-piece of the retaining pin assembly of FIG. 9;

FIG. 13 shows a cross-sectional view of the retaining pin assembly of FIG. 9;

FIG. 14 shows a side view of a lip shroud mounted to a lip with a retaining pin assembly mounted to the lip shroud;

FIG. 15 shows a cross-sectional view through the wear assembly of FIG. 1, showing the lip shroud mounted between excavator tooth assemblies;

FIGS. 16 to 18 are cross sectional views of the sequence of mounting a lip shroud to a lip and retaining the lip shroud relative to the lip by a retaining pin assembly;

FIG. 19 shows a perspective view of the location of a retaining pin assembly in the wear member assembly of FIG. 1;

FIG. 20 shows an exploded perspective view a retaining pin assembly in accordance with another embodiment of the invention;

FIG. 21 shows a perspective view of a cap of the retaining pin assembly of FIG. 20;

FIG. 22 shows a perspective view of a lock bolt of the retaining pin assembly of FIG. 20;

FIG. 23 shows a sectioned view of the body member of the retaining pin assembly of FIG. 20;

FIG. 24 shows a perspective view of the body member of FIG. 23;

FIG. 25 shows a perspective view of the foot-piece of the retaining pin assembly of FIG. 20;

FIG. 26 shows a sectional view of the foot-piece of FIG. 25;

FIG. 27 a sectional view of the retaining pin assembly of FIG. 20 in an assembled condition wherein the retaining pin is locked to the foot-piece with the lock bolt partially screwed into the foot-piece; and

FIG. 28 is sectional view of the retaining pin assembly of FIG. 20 in an assembled condition wherein the retaining pin is locked to the foot-piece with the lock bolt fully screwed into the foot-piece.

### DETAILED DESCRIPTION OF THE DRAWINGS

In the accompanying drawings, for the sake of clarity, like reference numerals are employed for like features where appropriate.

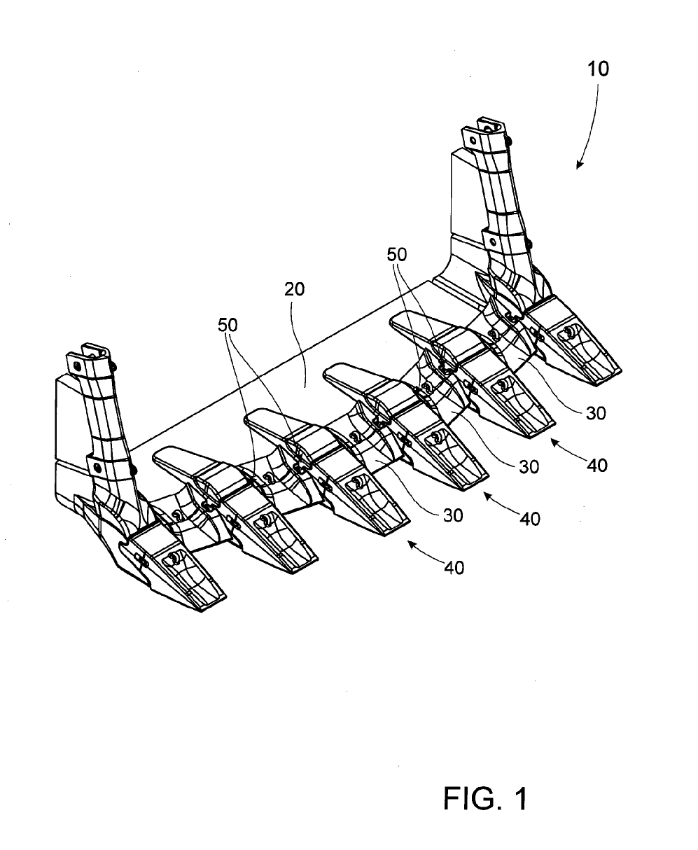

FIG. 1 shows a perspective view of a wear member assembly 10 for an excavation device such as an excavator bucket. The wear member assembly 10 comprises a lip 20, lip shrouds 30 and excavator tooth assemblies 40. A number of the tooth assemblies 40 are spaced along the lip 20. The lip shrouds 30 are mounted to the lip 20 and retained between the tooth assemblies 40 by retaining pin assemblies 50 as is discussed herein below.

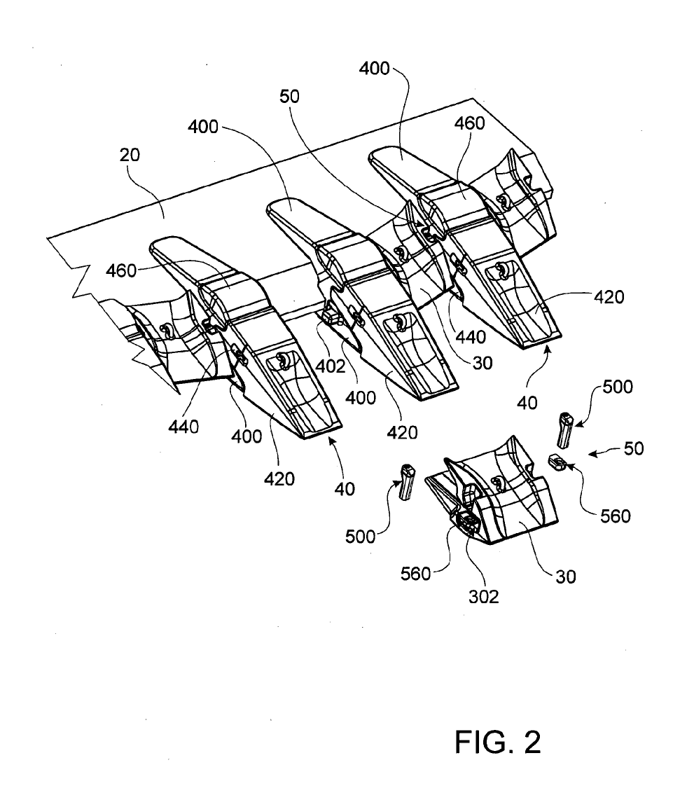

FIG. 2 shows a perspective part-exploded view of part of the wear member assembly 10. The tooth assemblies 40 shown comprise an adaptor 400, an excavator digging tooth 420, a locking pin 440 and a wear cap 460. The teeth 420 are mounted to the adaptors 400 and locked in place by the locking pins 440. The wear caps 460 are fixed on top of the adaptors 400. The adaptors 400 are in turn welded to the lip 20.

Each adaptor 400 has a boss 402 extending outwardly from each opposite side of the adaptor 400. Each lip shroud 30 has sockets 302 in its opposite sides, in which the bosses 402 are received to retain the lip shrouds 30 between the adaptors 400. Each lip shroud 30 is located between two adaptors 400 with bosses 402 of each of the adaptors 400 received in sockets 302 at opposite sides of the lip shroud 30.

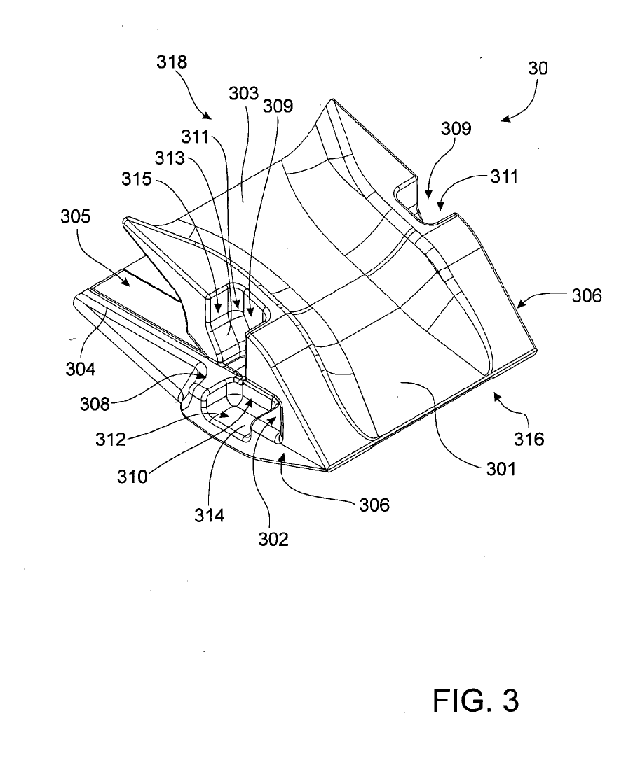

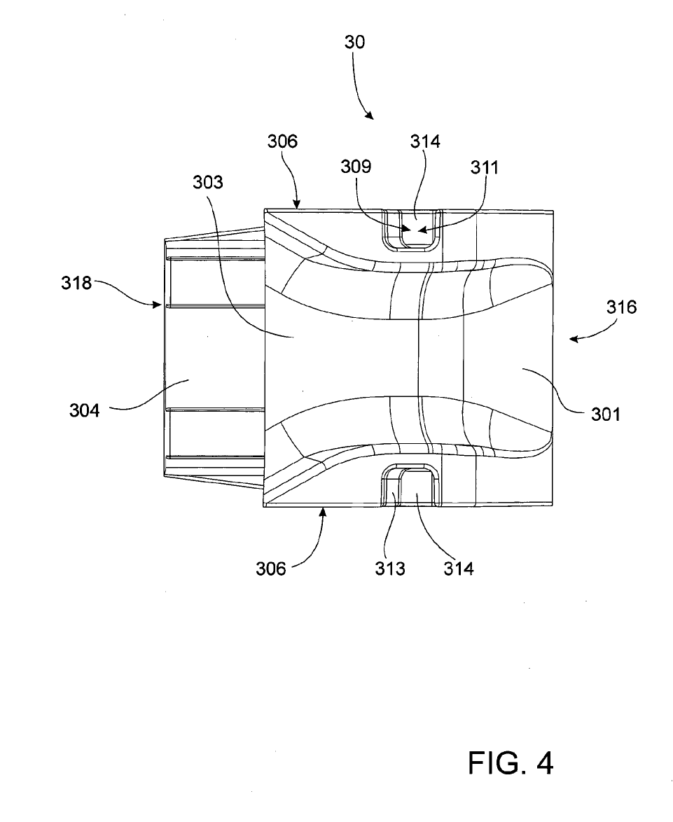

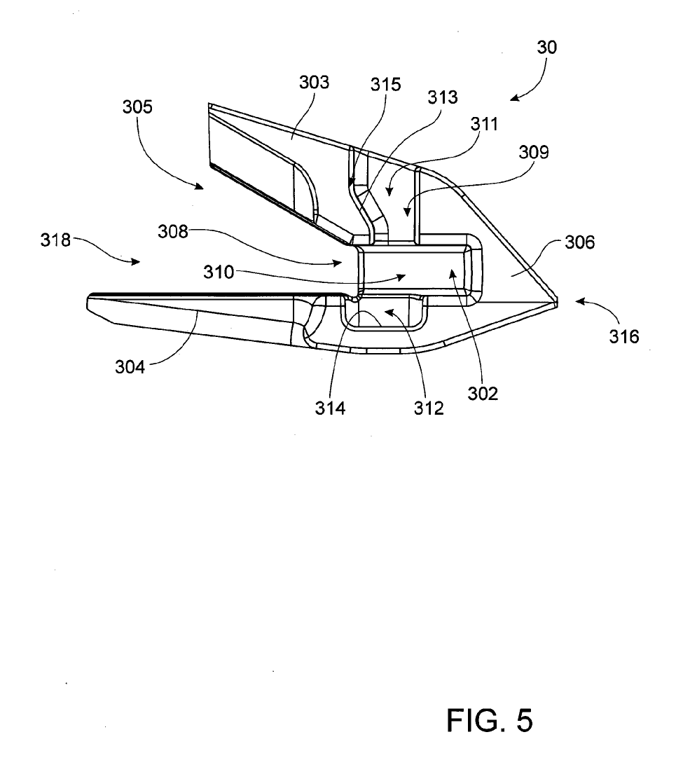

FIGS. 3-5 shows one of lip shrouds 30 in more detail. The lip shroud 30 has a front end 316 and a rear end 318. The lip shroud 30 comprises a leading portion 301 at the front end 316 and two forwardly converging legs 303,304 at the rear end 318. The legs 303, 304 have a gap 305 between them in which the lip 20 is received in a tongue-in-groove fashion to mount the lip shroud 30 to the lip 20. The lip shroud 30 has opposite sides 306. The sockets 302 are defined in each of the sides 306. A socket passage 308 leads from the gap 305 to the socket 302. The socket passage 308 is open to the socket 302 via a passage opening 310 between each socket 302 and socket passage 308.

A retaining pin passage 309 extends transversely with respect to the socket passage 308. The retaining pin passage 309 intersects the socket passage 308. The retaining pin passage 309 includes recesses 311, 312 above and below the socket passage 308, respectively. The recess 311 above the socket passage 308 has a load bearing face 315 on a tapered wall 313 of the lip shroud 30. The recess 312 below the passage has a floor 314. The socket 302 is dimensioned, shaped and configured to receive the boss 402 of the adaptor 400.

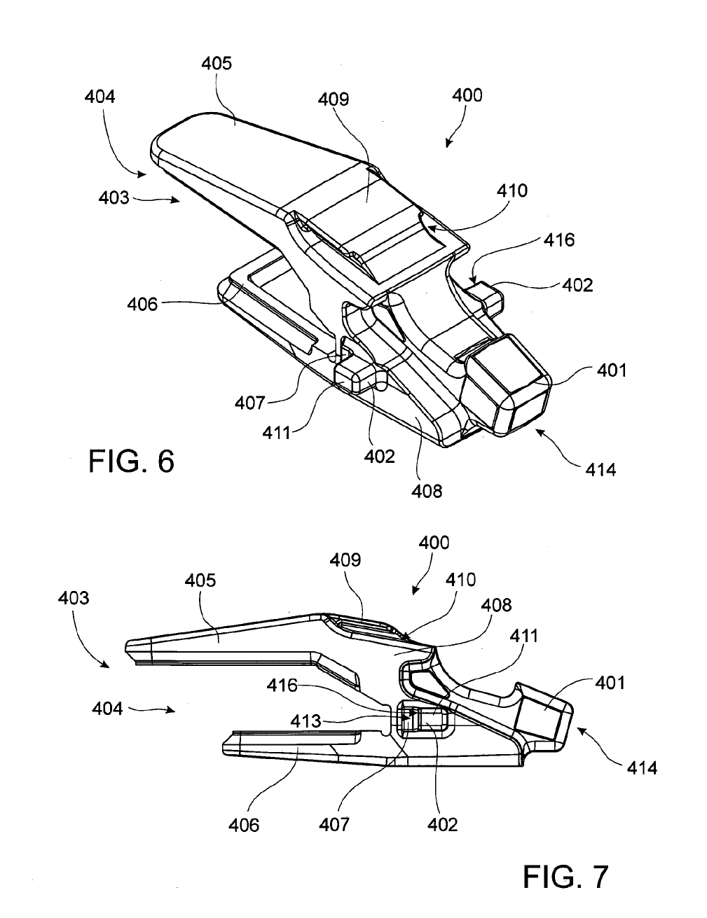

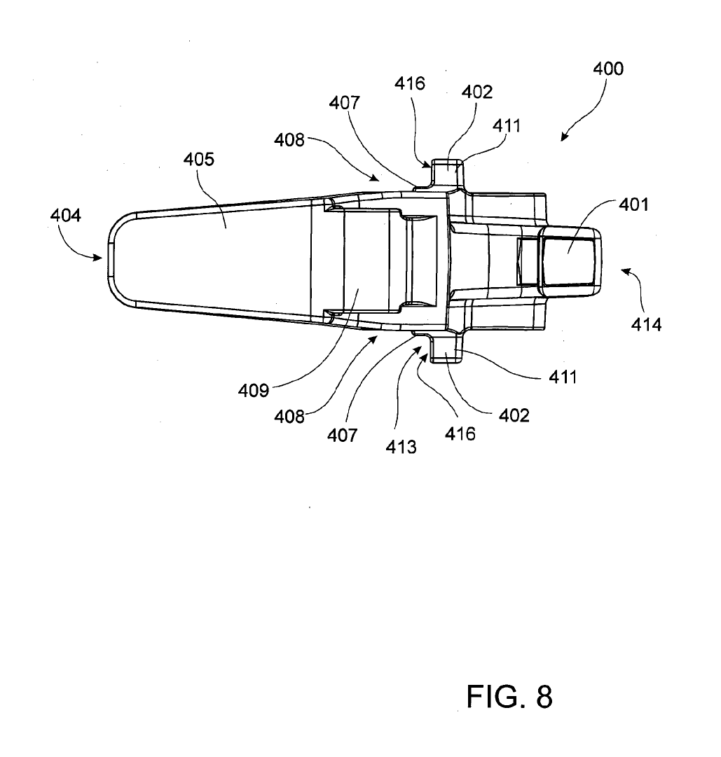

FIGS. 6 to 8 show the adaptor 400 in more detail. The adaptor 400 comprises a forward facing mounting nose 401 at a front end 414 of the adaptor 400 and a rear jaw 403 at a rear end 404 of the adaptor 400. The nose 401 has a spigot which is shaped to be received in a socket of the tooth 420. The jaw 403 comprises an upper leg 405 and a lower leg 406 which are adapted to receive part of the lip 20 between them. The adaptor 400 is mounted to the lip 20 and fixed to the lip 20 by welding the upper leg 405 and the lower leg 406 to the lip 20.

A wear cap mounting formation 409 at the top of the adaptor 400 has grooves 410 in which rails of a wear cap 460 is received for mounting the wear cap to the adaptor 400. The wear cap 460 is held in position on the mounting formation 409 by abutment against the tooth 420 when the tooth is mounted to the adaptor 400. The wear cap 460 can be removed by removing the tooth 420 from the adaptor 400.

The adaptor 400 further comprises the bosses 402 for engaging the lip shrouds 30. The bosses 402 stand proud of sides 408 of the adaptor 400. Each boss 402 comprise generally rectangular base 407 and a cube-shaped nub 411 formed on the base 407. The nub 411 is generally rectangular in cross section. The nub 411 has a rear face 416 which the retaining pin opposes and engages, in use. The base 407 has a platform 413 adjacent the nub 411.

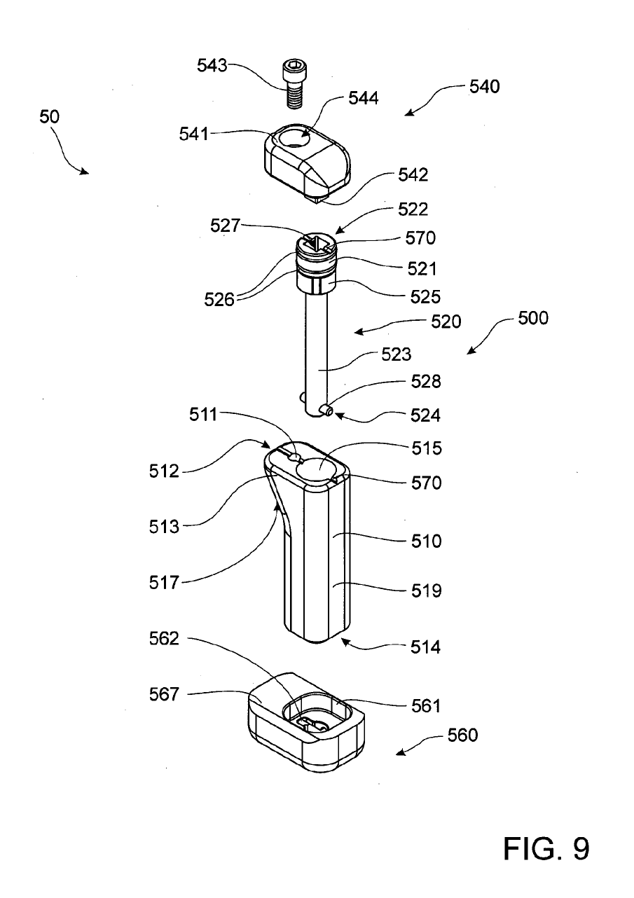

FIG. 9 shows an exploded view of one of the retaining pin assemblies 50. Each retaining pin assembly 50 comprises a retaining pin 500 and a foot-piece 560.

The retaining pin 500 comprises a body member 510, a key 520, and a cap 540.

The key 520 comprises a head 521 at an upper end 522 thereof and a shank 523 which extends from the head 521 to a lower end 524 of the key 520. A polyurethane bush 525 is located on the shank 523, below the head 521. The bush 525 is resiliently compressible. The head 521 has two circumferential grooves in a sidewall thereof, in which O-rings 526 are received. The head 521 and the bush 525 are both cylindrical and have the same outer diameter. The head 521 of the key has a square socket 527 in the top for receiving a square tip of a driver tool. A dowel pin 528 of the key 520 passes through the shank 523 at a distal end region of the key 520. The dowel pin 528 is transverse to a longitudinal axis of the shank 523.

The cap 540 comprises a body 541, a square key 542, a bolt 543, and a countersunk bolthole 544 in the body 541. The square key 542 projects downwardly from an underside of the body 541. The square key 542 is dimensioned to be received in the socket 527 of the head 521 of the key 520. The bolt 543 is rotatably received in the bolthole 544 with a shank thereof extending below the underside of the body 541 when seated in the bolthole 544. The bolt 543 is operable to screw into a screw hole 511 in the body member 510, thereby to fix the cap 540 relative to the body member 510. The square key 542 is receivable in the socket 527 of the key 521 to prevent rotation of the key 520 in the body member 510.

The body member 510 has an upper end 512 and a lower end 514. The body member 510 has a tapered portion 513 at the upper end 512 region having a second bearing face in the form of bearing face 517. The bearing face 517 engages the tapered wall 313 in the lip shroud. The body member 510 also has first bearing face in the form of a forward facing bearing face 519 which opposes and bears against the rear face 416 of the boss 402, in use.

A bore 515 extends through the body member 510 from the upper end 512 to the lower end 514. The bore 515 is enlarged at the upper end 512 so that a shoulder 516 (shown in FIG. 13) is defined partway into the bore from the upper end 512. The enlarged part of the bore 515 is dimensioned to receive the bush 525 and the head 521 of the key 520. The remainder of the bore 515 is dimensioned to receive the shank 523 of the key 520.

The head 521 of the key 520 and the upper end 512 of the body member 510 have alignment markings 570. The alignment markings 570 reveal the rotational orientation of the key 520 relative to the body member 510.

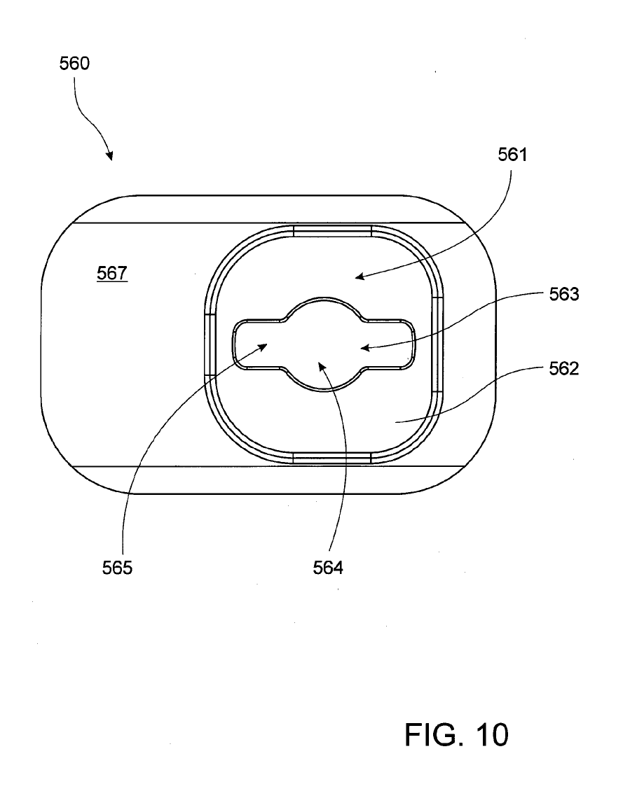

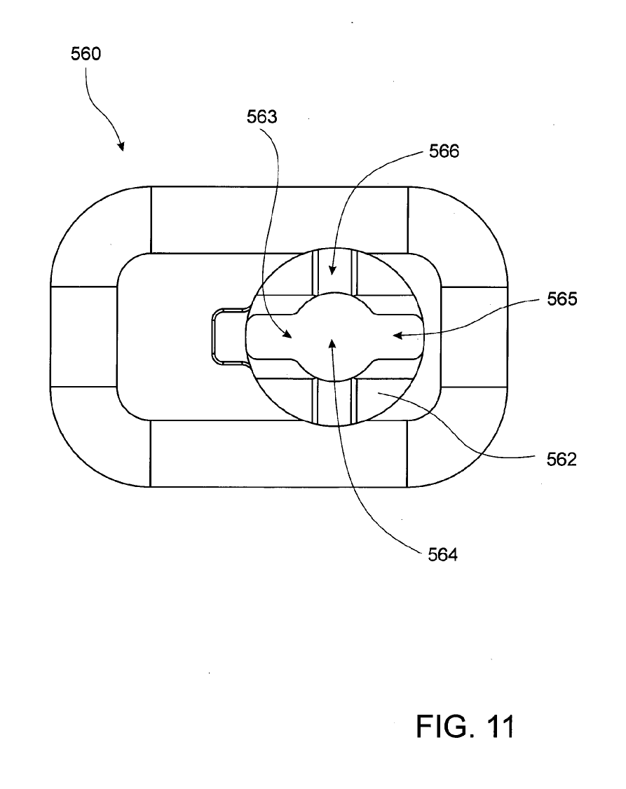

The foot-piece 560 is generally rectangular in top view. The foot-piece 560 has a recess 561 in which the lower end 514 of the body member 510 seats. The recess 561 is generally rectangular in plan view. A bearing face 567 of the foot-piece 560 surrounds the recess 561. The body member 510 is thus not rotatable relative to the foot-piece 560 when seated in the recess 561. FIGS. 10, 11 and 12 show the top, underside and cross section of the foot-piece 560, respectively. Referring to these drawings, a lock plate 562 is shown which defines a floor of the recess 561. The lock plate 562 has a keyway 563 therein. The keyway 563 is dimensioned and configured for the lower end 524 of the key 520 to pass there through. Specifically, the keyway 563 comprises a central hole 564 with a slot 565 extending across the central hole 564. An underside of the lock plate 562 has a groove 566 which extends across the central hole 564. The groove 566 is orthogonal to the slot 565. The groove 566 is adapted to receive the dowel pin 528 of the key 520 therein, thereby to lock the key 520 to the foot piece 560.

FIG. 13 shows the retaining pin assembly 50 in an assembled condition wherein the key 520 is in an unlocked position. The key 520 is located in the bore 515 of the body member 510. The lower end 524 of the shank 523 of the key 520, having the dowel pin 528, extends past the lower end 514 of the body member 510. The dowel pin 528 abuts the lower end 514 of the body member 510. The dowel pin 528 is longer than the diameter of the bore 515 at the lower end 514 of the body member 510, thereby capturing the key 520 in the body member 510. The key 520 and the body member 510 are thus inseparable without removing the dowel pin 528 from the shank 523. The bush 525 seats against the shoulder 516 in the bore 515. The bush 525 is resiliently compressed by applying a downward force to the head 521 of the key 520. Compressing the bush 525 moves the shank 523 downwardly relative to the body member 510 so that the dowel pin 528 is spaced from the lower end 514 of the body member 510. Turning the key 520 with a driver tool via the socket 527 rotates the key 520 and thus also rotates the dowel pin 528 about a longitudinal axis of the shank 523.

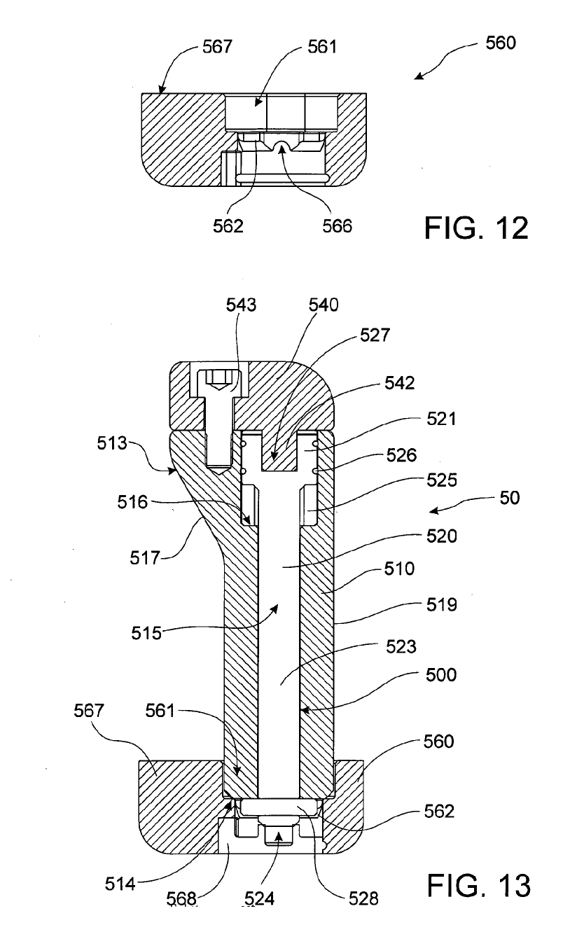

In order to lock the body member 510 to the foot-piece 560, the lower end 514 of the body member is first seated in the recess 561 in the foot-piece 560 with the key in the unlocked position as shown in FIG. 13. In the unlocked position, the dowel pin 528 of the key 520 is in register with the slot 564 in the lock plate 562. To move the key 520 to a locked position, downward pressure is first applied to the key 520 with the driver tool to compress the bush 525 and the key 520 is then rotated 90 degrees either clockwise or anti-clockwise. This causes the dowel pin 528 to first pass through the keyway 565 and then ride down the underside of the keyplate 562 as the key 520 is rotated, until the dowel pin 528 settles in the groove 566. FIG. 12 shows how the underside of the lock plate 562 ramps from the keyway 563 to the groove 566, such that the bush 525 is compressed when rotating the key 520 from the unlocked position to the locked position as the shank 523 is pulled downwardly during rotation of the key 520. Once the key 520 is in the locked position, the cap 540 is fixed to the upper end 512 of the body member 510. The square key 542 of the cap 540 is received in the socket 527 in the head 521 of the key 520 and the cap 540 is screwed in place by the bolt 543. The cap 540 prevents rotation of the key 520 relative to the body member 510. To unlock the body member 510 from the foot-piece 560, the cap 540 is removed and the key 520 is rotated 90 degrees by a driver tool so that the key 520 is once again in the unlocked position shown in FIG. 13. In order to rotate the key 520 from the locked position to the unlocked position, the bush 525 is first compressed by applying a downwards force on the head 521 to un-seat the dowel pin 528 from the groove 566.

A plug 568 of the foot-piece 560 is shown in FIG. 12. The plug 568 closes off the bottom of the foot-piece 560 to prevent the ingress of fines to the lock plate 562. Similarly, the O-rings 526 at the head 521 of the key 520 prevent ingress of fines into the bore 515 of the body member 510.

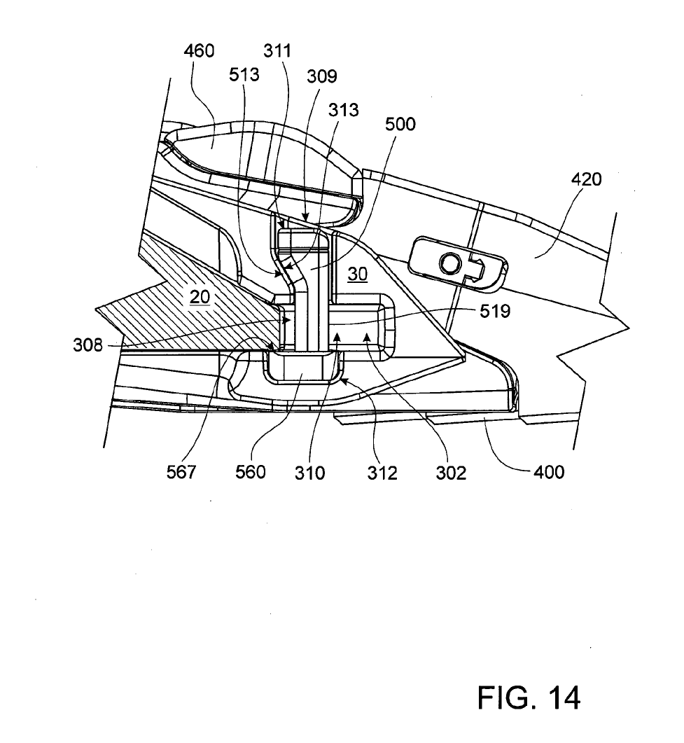

Referring to FIG. 14, the foot-piece 560 is fixed in the lower recess 312 of the lip shroud 30. The foot-piece 560 is fixed in place by an adhesive or the like. A person in the art will appreciate that the foot-piece 560 may be integrally formed as part of the lip shroud 30. The lip shroud 30 is configured so that part of the foot-piece 560 abuts the underside of the lip 20 when the lip shroud 30 is mounted to the lip 20. The body member 510 is locked to the foot-piece 560 by the key 520. The tapered portion 513 of the body member 510 wedgingly engages the tapered wall 313 in the upper recess 311 of the lip shroud 30.

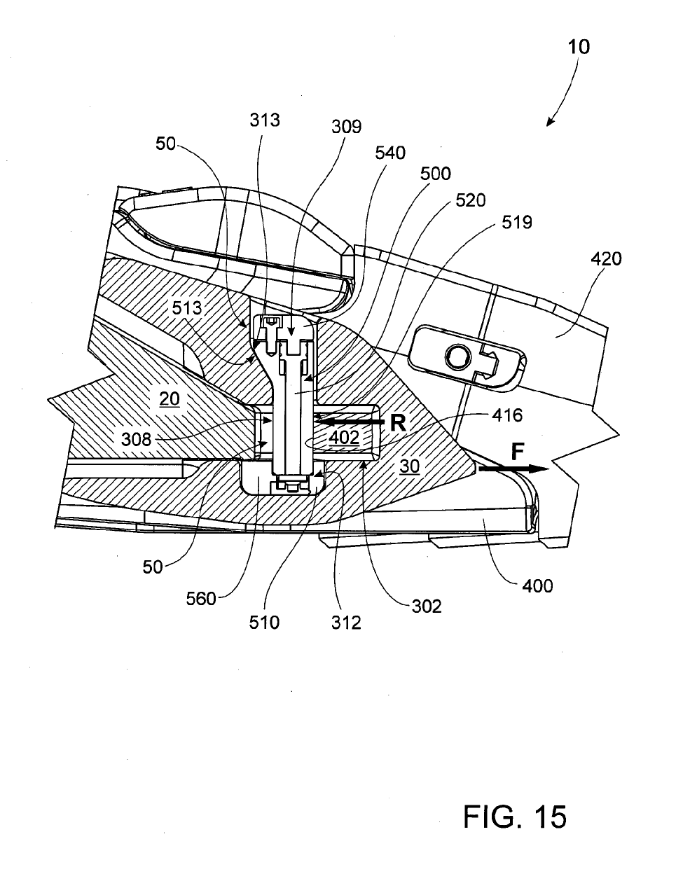

Referring to FIG. 15, the wear assembly 10 is shown in a mounted condition. In the mounted condition the boss 402 of the adaptor 400 is captured in the socket 302 by the retaining pin assembly 50. The retaining pin assembly 50 retains the lip shroud 30 in its position mounted to the lip 20. The body member 510 of the retaining pin 500 obstructs the socket passages 308 through which the boss 402 was displaced into the socket 302. The body member 510 thus captures the bosses 402 in the sockets 302. Any forward force “F” on the lip shroud 30 is counteracted by a reaction force “R” where the boss 402 bears against the body member 510 of the retaining pin 500. The retaining pin 500 in turn bears against the tapered wall 313 and the foot-piece 560. The foot-piece 560 is fixed in the recess 312 so any force transmitted to the foot-piece 560 by the retaining pin in the direction of the reaction force “R” is transmitted to the lip shroud 30. Were it not for the body member 510 in the socket passage 308 bearing against the tapered wall 313 and the foot-piece 560, the forward force “F” would dislodge the lip shroud 30 from the lip 20.

Part of the foot-piece 560 abuts the underside of the lip 20. Another part of the foot-piece 560 abuts the underside of the boss 402. The abutment of the foot-piece 560 against the underside of the lip 20 and the underside of the boss 402 prevents the foot-piece 560 from being lifted from the recess 312.

The wedging engagement between the tapered portion 513 of the body member 510 and the tapered wall 313 in the upper recess 311 of the lip shroud 30 pushes the lip shroud 30 onto the lip 20 as the key 520 is locked to the foot-piece 560. The lip shroud 30 is semi-statically mounted to the lip 20.

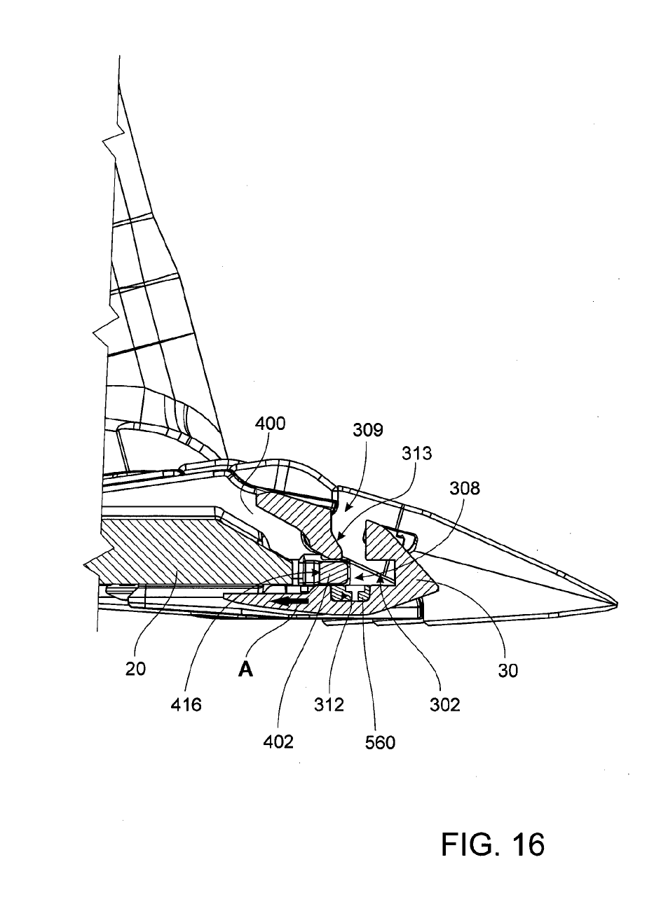

FIGS. 16 to 18 are cross sectional views of the sequence of mounting the lip shroud 30 to the lip 20 and retaining the lip shroud 30 relative to the lip 20 by a retaining pin assembly 50.

FIG. 16 shows the lip shroud being mounted to the lip 20 by sliding displacement of the lip shroud 30 in a rearward direction “A” onto the lip 20. The boss 402 is displaced along the socket passage 308 toward the socket 302 as the lip shroud 30 displaced toward the lip 20. As discussed, the foot-piece 560 is already mounted in the recess 312 of the lip shroud 30.

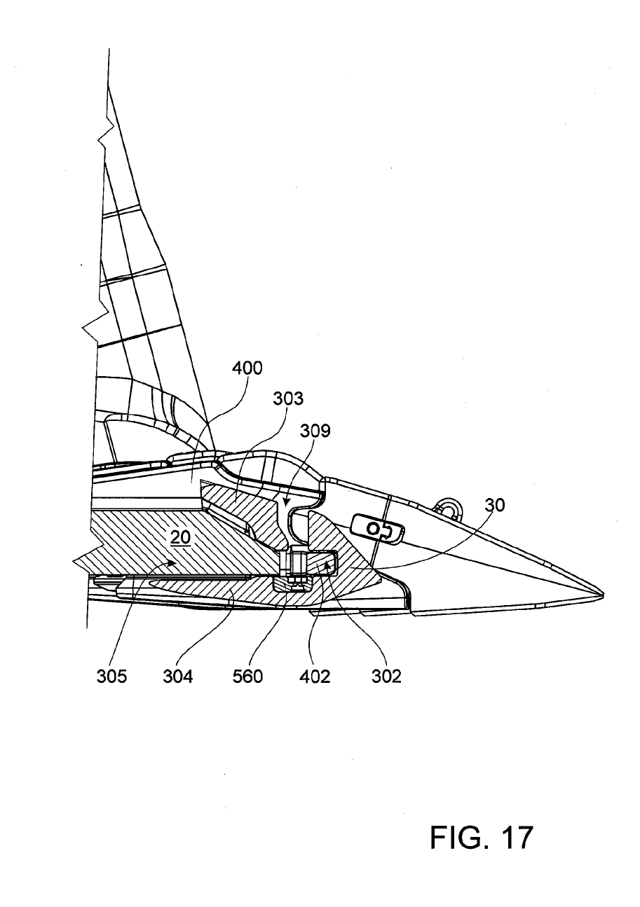

FIG. 17 shows the lip shroud 30 mounted to the lip 20. A leading portion of the lip 20 is located in the gap 305 between the legs 303,304 in a tongue-in-groove fashion to mount the lip shroud 30 to the lip 20. The boss 402 is located in the socket 302 of the lip shroud 30.

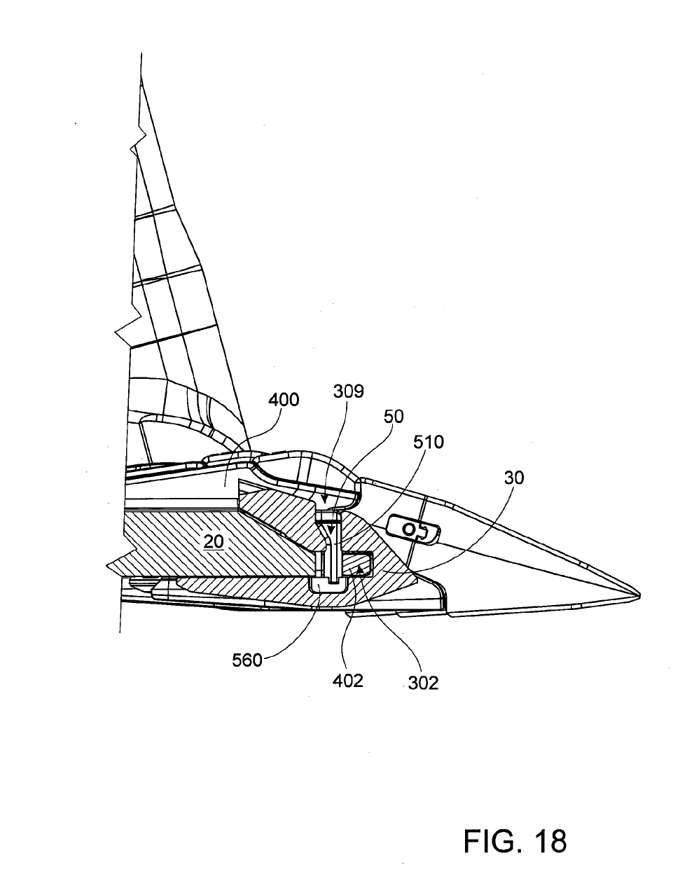

FIG. 18 is the same as FIG. 17, except that the lip shroud 30 is retained in its position mounted to the lip 20 by the retaining pin assembly 50. The body member 510 of the retaining pin assembly 50 is received in the retaining pin passage 309 in its position obstructing displacement of the boss 402 from the socket 302. The body member 510 is releasably locked in the retaining pin passage 309 by turning the key 520 (not shown in FIG. 18) from the un-locked position to the locked position. The key is itself 520 locked in the locked position by the cap 540.

To release the lip shroud 30 from between the adaptors 400, the key 520 is un-locked from the foot-piece 560 and the body member 510 removed from its obstructive position in the socket passage 308. The lip shroud 30 is then removed by pulling it forward and out of engagement with the bosses 402.

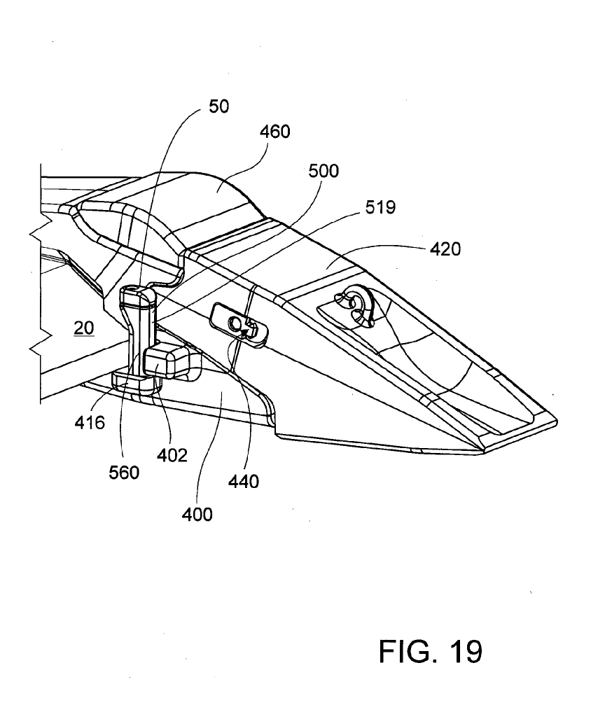

FIG. 19 is a perspective view of part of the wear member assembly 10, but with the lip shroud 30 removed. The retaining pin assembly 50 is shown with the foot-piece 560 at the location it would be in had it been located in a lip shroud 30 mounted between adaptors 400. The body member 510 is shown at its position relative to the boss 402 wherein the body member would capture the boss 402 in the socket 302 of the lip shroud 30.

The side-by-side engaged retainment of lip shrouds 30 between adaptors 400 provide for a more robust structure than had the adaptors 400 not engaged the lip shrouds 30. The loads experienced by the adaptors 400 and shrouds 30 during a digging operation are distributed between the adaptors 400 and the shrouds 30 because of their engagement with each other. A more even distribution of load between wear members of a wear member assembly is beneficial to avoid premature failing and wear of the wear members.

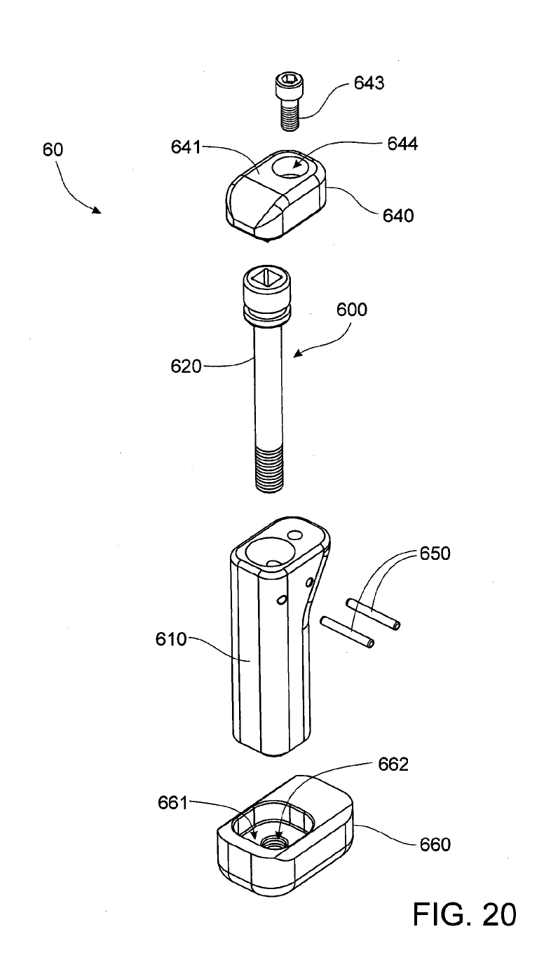

FIG. 20 shows an exploded perspective view of a retaining pin assembly 60 in accordance with another embodiment of the invention. Each retaining pin assembly 60 comprises a retaining pin 600 and a foot-piece 660. The retaining pin 600 has various components and features which are the same or similar to components or features of the retaining pin 500. Selected features of the retaining pin 600 are described as the same as features of the retaining pin 500 for conciseness.

The retaining pin 600 comprises a body member 610, a lock member in the form of a lock bolt 620, a cap 640 and two capture pins 650.

FIG. 21 is a perspective view of the cap 640. The cap 640 is the same as the cap 640 of the retaining pin 500. The cap 640 comprises a body 641, a square key 642, a bolt 643(shown in FIG. 20), and a counter-bored bolthole 644 in the body 641.

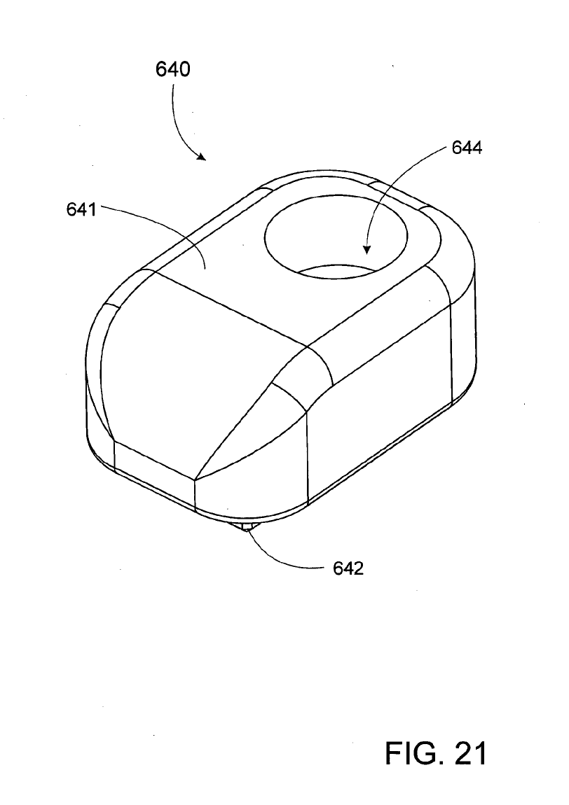

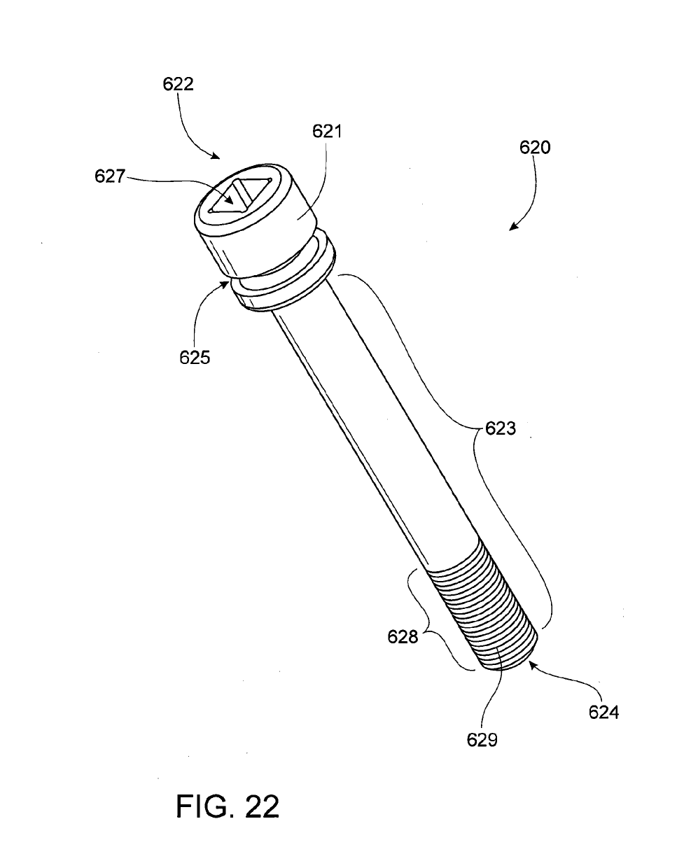

FIG. 22 shows a perspective view of the lock bolt 620. The lock bolt 620 comprises a head 621 at an upper end 622 thereof and a shank 623 which extends from the head 621 to a lower end 624 of the key 620. The head 621 has a circumferential groove 625 in a sidewall thereof. The groove 625 is dimensioned to receive the capture pins 650 to seat in the groove 625. The head 621 is generally cylindrical. The head 621 has a square socket 627 in the top for receiving a square tip of a driver tool. A screw-threaded distal end region 628 of the shank 623 has a lock formation in the form of a screw-thread 629.

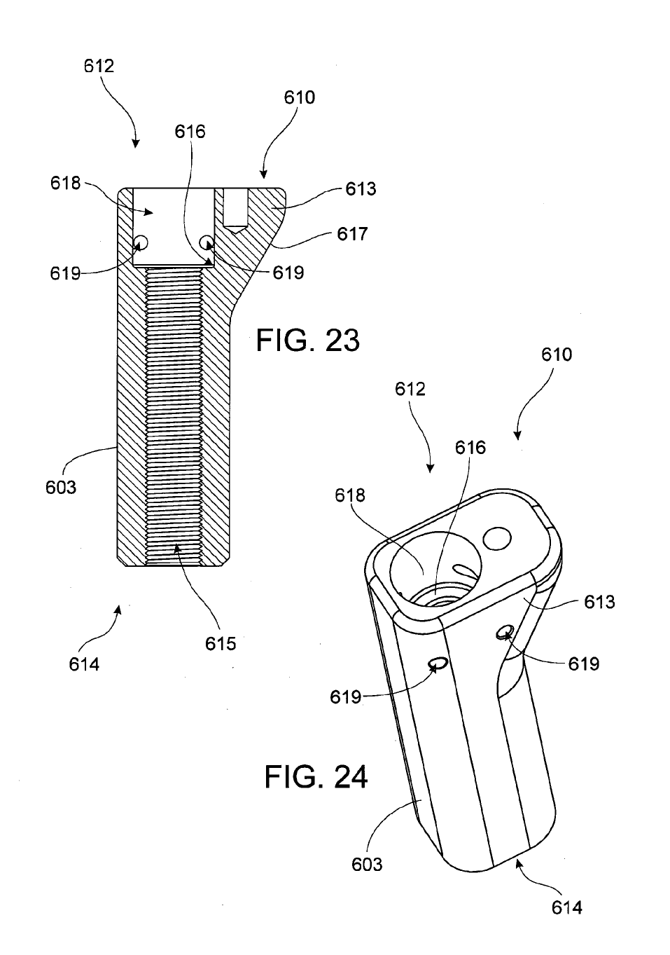

FIGS. 23 and 24 show a sectioned view and a perspective view, respectively, of the body member 610. The body member 610 has an upper end 612 and a lower end 614. The body member 610 has an enlarged tapered portion 613 at the upper end 612 region thereof for wedgingly engaging the tapered wall 313 in the lip shroud. The tapered portion 613 has bearing face 617 which bears against the tapered wall 313. The body member 610 also has a forward facing bearing face 603 which opposes and bears against the rear face 416 of the boss 402, in use. A bore 615 extends through the body member 610 from the upper end 612 to the lower end 614. The bore 615 has an enlarged counterbore 618 at the upper end 612 so that a shoulder 616 is defined partway into the bore 615 from the upper end 612. The counterbore 618 is dimensioned to receive the head 621 of the key 620. The remainder of the bore 615 is dimensioned to receive the shank 623 of the lock bolt 620.

The body member 610 has two pin holes 619 which transverse the counterbore 618. The pin holes 619 receive the capture pins 650 therein to capture the head 621 of the lock bolt 620 in the counterbore 618. The capture pins extend transversely to the bore 615.

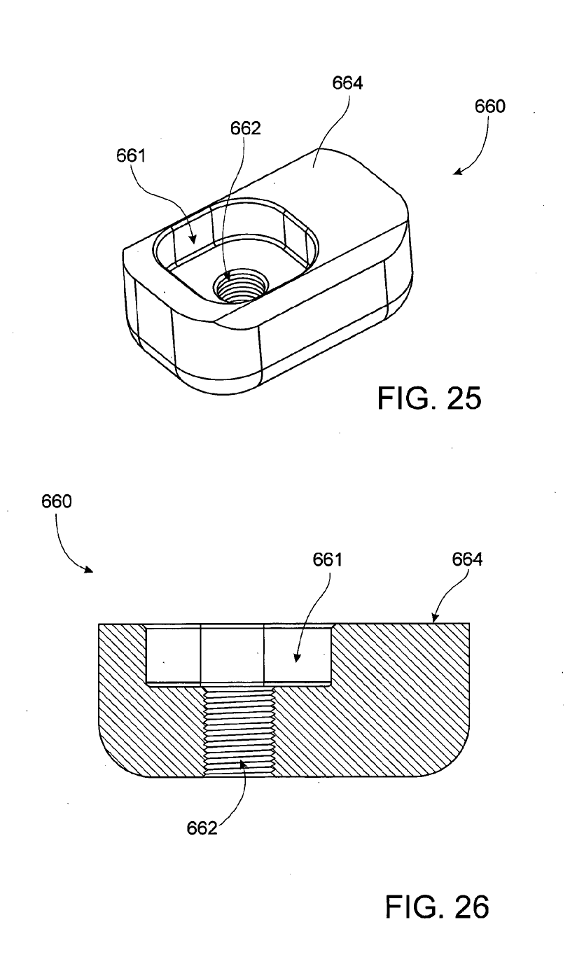

FIGS. 25 and 26 show a perspective view and sectional view of the foot-piece 66, respectively. The foot-piece 660 is generally rectangular in top view. The foot-piece 660 has a recess 661 in which the lower end 614 of the body member 610 seats. The recess 661 is generally rectangular in plan view. The body member 610 is thus not rotatable relative to the foot-piece 660 when seated in the recess 661. The foot-piece 660 has a screw-threaded hole 662 in the base of the recess 661. The hole 662 screw-threadingly engages the lock bolt 620, in use, thereby to lock the lock bolt 620 to the foot piece 660. The foot-piece 660 has a bearing face 664 which bears against the under side of the lip 20 and boss 402, in use.

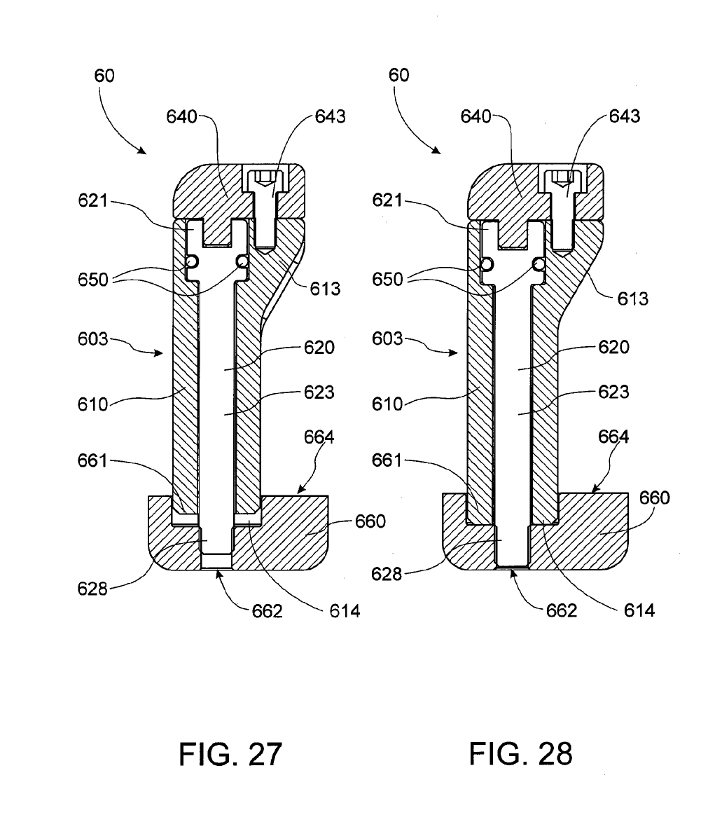

FIGS. 27 and 28 show sectional views of the retaining pin assembly 60 in an assembled condition wherein the retaining pin 600 is locked to the foot-piece 660. The retaining pin 600 is locked to the foot-piece 660 by the lock bolt 620 being screwed into the screw hole 662 of the foot-piece 660. FIG. 27 shows the lock bolt 620 partially screwed into the screw hole 662 and FIG. 28 shows the lock bolt fully screwed into the screw hole 662. By screwing the lock bolt 620 into the screw hole 662, the lock bolt 620 pulls the lock body 610 closer to the foot-piece 660. In use, the tapered portion 613 is brought to bear against the tapered wall 313 of the lip shroud 30 as the lock bolt 620 is screwed into the foot-piece 660. The tapered portion 613 has a bearing face 617 which bears against the tapered wall 313. This allows for the lip shroud 30 to be pulled onto the lip 20 by tightening of the lock bolt 620.

The head 621 of the lock bolt 620 is captured in the counterbore 618 by the capture pins 650. The lock bolt 620 is thus constrained from axial displacement along the bore 615. The screw-threaded end region 628 of the shank 623 of the lock bolt 620 extends past the lower end 614 of the body member 610.

Throughout the specification the aim has been to describe the invention without limiting the invention to any one embodiment or specific collection of features. Persons skilled in the relevant art may realize variations from the specific embodiments that will nonetheless fall within the scope of the invention. For example, the adaptor 400 may comprise an adaptor body and an adaptor nose, with the bosses 402 located on the adaptor nose. It will be appreciated that various other changes and modifications may be made to the embodiment described without departing from the spirit and scope of the invention.

1. A wear member assembly for a lip of an earth excavating device, the wear member assembly comprising:
a first wear member mounted to the lip, the first wear member having a front end, a rear end, and opposite sides, the first wear member including a boss extending outwardly from at least one of the opposite sides;
a second wear member mounted on the lip adjacent the first wear member, the second wear member having a front end, a rear end, and opposite sides, the second wear member including:
a socket in at least one of the opposite sides, the socket adapted to receive the boss of the first wear member;
a retaining pin passage in communication with the socket; and
a retaining pin removably located in the retaining pin passage, the retaining pin having a first bearing face adapted to oppose and engage a face of the boss received in the socket and a second bearing face which opposes and engages a load bearing face of the retaining pin passage.

2. The wear member assembly of claim 1, wherein the second wear member includes a socket passage open to the socket, the socket passage adapted to have the boss displaced along the socket passage to the socket, and wherein the retaining pin passage extends transversely with respect to the socket passage.

3. The wear member assembly of claim 1, wherein the retaining pin comprises:
a lock member having a head and a shank with a lock formation; and
a body member having a bore in which the shank of the lock member is received.

4. The wear member assembly of claim 3, wherein the body member includes a tapered portion having the second bearing face.

5. The wear member assembly of claim 3, wherein at least part of the shank having the lock formation protrudes from an end of the body member.

6. The wear member assembly of claim 3, wherein the head of the lock member is rotatably captured in the body member.

7. The wear member assembly of claim 3 including
a retaining pin assembly comprising:
the retaining pin; and
a foot-piece which the lock formation of the lock member engages to lock the retaining pin to the foot-piece.

8. The wear member assembly of claim 7, wherein the foot-piece has a bearing face which engages one of the lip or the boss.

9. The wear member assembly of claim 8, wherein the boss comprises a base and a nub formed on the base, the bearing face of the foot-piece engaging the base of the boss.

10. The wear member assembly of claim 8, wherein the foot-piece is integrally formed with the lip shroud.

11. The wear member assembly of claim 1, wherein the first wear member is an adaptor of an excavator tooth assembly.

12. The wear member assembly of claim 11, wherein the second wear member is a lip shroud.

13. The wear member assembly of claim 11, wherein the adaptor has a boss projecting from both opposite sides.

14. The wear member assembly of claim 13, wherein the boss is rectangular in cross-section.

15. A lip shroud adapted to be mounted on a lip of an earth excavating device, the lip shroud having a front end, a rear end, and opposite sides, the lip shroud including:
a socket in at least one of the opposite sides;
a retaining pin passage in communication with the socket, the retaining pin passage adapted to receive a retaining pin.

16. The lip shroud of claim 15 including a socket passage open to the socket, and wherein the retaining pin passage extends transversely with respect to the socket passage.

17. The lip shroud of claim 16, wherein the lip shroud has the socket, socket passage and retaining pin passage in both opposite sides.

18. The lip shroud of claim 15, wherein the retaining pin passage preferably includes a recess in the side of the lip shroud, the recess being adapted to receive a foot-piece which the retaining pin engages.

19. A retaining pin comprising:
a lock member having a head and a shank, the lock member including a lock formation on the shank distal to the head; and
a body member having opposite ends and a bore extending between the opposite ends, the bore adapted to receive the shank of the lock member, the body member including a tapered portion at one of the opposite ends;
wherein the lock formation is located outwardly of the body member when the shank is received in the bore.

20. The retaining pin of claim 19, wherein the head of the lock member is rotatably captured in the body member.

21. The retaining pin of claim 20, wherein the head of the lock member has a circumferential groove and the retaining pin includes one or more capture pins extending transversely through the bore of the body member to seat in the circumferential groove of the lock member, thereby to rotatably capture the head of the lock member in the body member.

22. The retaining pin of claim 19, wherein the lock member is a lock bolt and the lock formation is a screw thread.

23. The retaining pin of claim 22, including a foot-piece having a screw-threaded hole which the lock bolt screw-threadingly engages to lock the body member to the foot-piece.

24. The retaining pin of claim 23, wherein the foot-piece has a non-round recess adapted to receive one of the opposite ends of the body member in an arrangement wherein the foot-piece is prevented from rotating relative to the body member.

25. A retaining pin assembly comprising the retaining pin of claim 19 and a foot-piece which the lock member locks to the body member.

26. The retaining pin assembly of claim 25, wherein the lock member is a lock bolt and the lock formation is a screw thread, and wherein the foot-piece has a screw-threaded hole which the lock bolt screw-threadingly engages to lock the body member to the foot-piece.

27. The retaining pin assembly of claim 26, wherein the foot-piece has a non-round recess adapted to receive one of the opposite ends of the body member in an arrangement wherein the foot-piece is prevented from rotating relative to the body member.

28. The retaining pin of claim 19, wherein the lock member is a key and the lock formation is a dowel pin.

29. The retaining pin of claim 28, wherein the key includes a resiliently compressible bush located on the shank below the head.

30. The retaining pin of claim 29, wherein the bore of the body member has a shoulder against which the bush seats.

31. The retaining pin of claim 28, including a foot-piece having a keyway through which the dowel pin is received in an unlocked position of the key and wherein the lock formation engages the foot-piece when the key is in a locked position.

32. The retaining pin of claim 31, wherein the keyway is dimensioned and configured to allow the dowel pin to pass through the keyway when in register with the keyway, but to prevent retraction of the key from the foot-piece if the key is rotated 90 degrees after the lock formation passes through the keyway.

33. The retaining pin of claim 32, wherein the foot-piece includes a lock plate and the keyway is formed in the lock plate of the foot-piece.

34. The retaining pin of claim 32, wherein the dowel pin is located at a distal end region of the shank of the key and the lock plate has a slot through which the dowel pin may pass when in register with the slot.

35. A retaining pin assembly comprising the retaining pin of claim 28 and a foot-piece having a keyway through which the dowel pin is received in an unlocked position of the key and wherein the lock formation engages the foot-piece when the key is in a locked position.

36. The retaining pin assembly of claim 35, wherein the foot-piece has a non-round recess adapted for receiving one of the opposite ends of the body member in an arrangement wherein the foot-piece is prevented from rotating relative to the body member.

37. The retaining pin of claim 19 including a cap, the cap releasably securable to the one of the opposite ends of the body member and including a key to engage the head of the lock member, thereby to constrain rotation of the lock member.

38. The retaining pin of claim 37, wherein the lock member includes a non-round socket in its head to receive the key of the cap.

39. The retaining pin of claim 37, wherein the body member has a screw hole at its end for receiving a screw of the cap, thereby to secure the cap to the body member.

40. The retaining pin of claim 37, wherein the cap includes a bolt for screwing into the screw hole of the body member.

41. An adaptor mountable to a lip of an earth excavating device, the adaptor having a front end, a rear end, and opposite sides, the adaptor including a boss projecting from at least one of the opposite sides, the boss comprising a raised base on the at least one of the opposite sides and a nub extending from the base.

42. A method of releasably mounting a second wear member adjacent a first wear member mounted to a lip of an earth excavating device, the method including:
displacing the second wear member relative to the first wear member such that a boss extending outwardly from a side of the first wear member is displaced into a socket in the side of the second wear member; and
locating a retaining pin in a retaining passage of the first wear member such that a first bearing face of the retaining pin opposes and engages a face of the boss received in the socket and a second bearing face of the retaining pin opposes and engages a load bearing face of the retaining pin passage.

43. The method of claim 42, further including locking the retaining pin to the second wear member.
